(19) United States
(12) Patent Application Publication
(10) Pub. No.: US 2026/0057190 A1
(43) Pub. Date: Feb. 26, 2026

(54) DYNAMIC LARGE LANGUAGE MODEL PROMPT GENERATION FOR REQUEST REJECTIONS

(71) Applicant: Royal Bank of Canada, Toronto (CA)

(72) Inventors: Camillia Hanaan Amin, Burlington (CA); Alex Groiser, Thornhill (CA); Colin Ryan, Toronto (CA)

(21) Appl. No.: 19/304,327

(22) Filed: Aug. 19, 2025

Related U.S. Application Data
(60) Provisional application No. 63/685,478, filed on Aug. 21, 2024.

(51) Int. Cl. G06F 40/40; G06F 40/279

(52) U.S. Cl. CPC G06F 40/40; G06F 40/279

(57) ABSTRACT

Rejection information for a request rejection for the rejected request is obtained. The rejection information comprises a rejected request code for the rejected request and a refusal code, which are extracted from the rejection information. The rejected request code is used to retrieve related request code text from a first document. The related request code text comprises a rejected request code characterization for the rejected request code itself, and additional request codes that are related to the rejected request code and respective additional request code characterizations for the additional request codes. The refusal code is used to retrieve at least one resolution text from a second document. At least part of the related request code text and at least part of the resolution text are dynamically combined into a prompt requesting a recommendation for resolving the request rejection, and the prompt is submitted to an LLM.

### CROSS-REFERENCE TO RELATED APPLICATION

This application claims priority to, and the benefit of, U.S. Provisional Application No. 63/685,478 filed on Aug. 21, 2024, the teachings of which are hereby incorporated by reference.

### TECHNICAL FIELD

The present disclosure relates to machine learning, more particularly to large language models (LLMs) and still more particularly to dynamic prompt generation.

### BACKGROUND

“You keep using that word. I do not think it means what you think it means.” Thus said the legendary swordfighter Inigo Montoya to his partner, the alleged genius Vizzini, in the classic fantasy film The Princess Bride. Although spoken in a fictional medieval world, this oft-repeated phrase has new relevance in the era of generative artificial intelligence.

One example of generative artificial intelligence is the “large language model” (LLM). An LLM is a computational model which has been trained using a large corpus of human-created text and is able to respond to human queries with generally meaningful output.

The query submitted to a large language model is called a “prompt”. A poorly worded prompt (for example, using a word that does not mean what one thinks it means) may elicit less than optimal results from an LLM, and there are various approaches to designing a prompt to obtain better responses from an LLM. In many cases, this is a learned skill.

There are many contexts in which a suitably trained LLM can provide useful feedback on a real-world problem if it is given an appropriate prompt, but may fail to do so, or provide feedback of limited value, where the prompt is deficient. One such context is the rejection of a request in a bureaucratic milieu. One might ask an LLM something like “why was this rejected and how do I fix it?” and include text from the rejection. While such a prompt may in some cases elicit a useful reply, this plaintiff plea may be insufficient where the nature of the request, and the reason for the rejection, is highly specific. For example, in contexts where numeric or alphanumeric codes are used for the request and/or the rejection, a generic prompt may fail to achieve appropriate guidance on potential remediation.

It is therefore desirable to develop methods for dynamically generating prompts for seeking LLM guidance in overcoming rejection requests.

### SUMMARY

In one aspect, a computer-implemented method for dynamically generating a large language model (LLM) prompt for a rejected request is provided. The method comprises obtaining rejection information for a request rejection for the rejected request. The rejection information comprises a rejected request code for the rejected request, and a refusal code for the rejected request. The rejected request code and the refusal code are extracted from the rejection information. The method further comprises using at least the rejected request code to retrieve related request code text from a first document. The related request code text comprises a rejected request code characterization for the rejected request code itself, and additional request codes that are related to the rejected request code and respective additional request code characterizations for the additional request codes. The refusal code is used to retrieve at least one resolution text from a second document. The method further comprises dynamically combining at least part of the related request code text and at least part of the resolution text into a prompt requesting a recommendation for resolving the request rejection, and the prompt is submitted to an LLM.

In some embodiments, using at least the rejected request code to retrieve the related request code text from the first document comprises using the rejected request code to obtain a rejected request code text embedding for the rejected request code characterization, comparing the rejected request code text embedding to candidate text embeddings for respective corresponding candidate characterizations in the first document to identify a subset of the candidate text embeddings that are similar to the rejected request code text embedding according to a similarity threshold, and returning, as the respective additional request code characterizations, those of the candidate characterizations for which the respective corresponding candidate text embeddings satisfy the similarity threshold. In particular embodiments, the similarity threshold may be a vector similarity threshold.

In some embodiments, the method further comprises extracting supplemental data from request history data for a subject of the request and, before submitting the prompt to the LLM, incorporating at least part of the supplemental data into the prompt. In particular embodiments, the supplemental data includes at least one of supplemental request codes and supplemental refusal codes.

In some embodiments, dynamically combining at least part of the related request code text and at least part of the resolution text into the prompt uses few-shot prompting.

In some embodiments, the prompt comprises a populated copy of a template. The template comprises an identifier of a persona to be adopted by the LLM and a resolution request for the request rejection, and the copy of the template is populated by enriching the resolution request with the at least part of the related request code text and the at least part of the resolution text.

In some embodiments, the prompt further comprises a prefix specifying a format of a response for the LLM. In particular embodiments, the format comprises a menu of options.

In some embodiments, using at least the rejected request code to retrieve the related request code text from the first document comprises using the rejected request code to identify at least one keyword for the rejected request code characterization, and using the at least one keyword to identify, as the respective additional request code characterizations, those candidate characterizations in the first document that contain at least one of the keyword(s).

In other aspects, the present disclosure is directed to a computer program product comprising at least one tangible, non-transitory computer readable medium embodying instructions which, when executed by at least one processor of a data processing system, cause the data processing system to implement any of the methods described above.

In still further aspects, the present disclosure is directed to a data processing system comprising at least one processor and memory coupled to the at least one processor, wherein the memory contains instructions which, when executed by the at least one processor, cause the data processing system to implement any of the methods described above.

### BRIEF DESCRIPTION OF THE DRAWINGS

These and other features will become more apparent from the following description in which reference is made to the appended drawings wherein:

FIG. 1 shows a computer network that comprises an example embodiment of a system for providing online services in support of a medical practice;

FIG. 2 depicts an example embodiment of a server in a data center;

FIG. 3 is a flow chart showing a non-limiting illustrative method for dynamically generating an LLM prompt for a rejection;

FIG. 3A is a flow chart showing a first non-limiting illustrative method for using a rejected request code to retrieve related request code text from a first document;

FIG. 3B is a flow chart showing a second non-limiting illustrative method for using a rejected request code to retrieve related request code text from a first document;

FIG. 4 is an illustrative, non-limiting architecture diagram for a system according to an aspect of the present disclosure;

FIG. 5 is a flow chart showing an illustrative process flow for the system of FIG. 4; and

FIG. 6 is a flow chart showing an illustrative user flow for a user of the system of FIG. 4.

### DETAILED DESCRIPTION

Broadly speaking, aspects of the present disclosure implement a novel and inventive application of Retrieval Augmented Generation (RAG) in order to dynamically generate prompts for seeking large language model (LLM) guidance in overcoming rejection requests. RAG uses information from reliable external sources to improve the reliability and accuracy of output from generative artificial intelligence models such as LLMs.

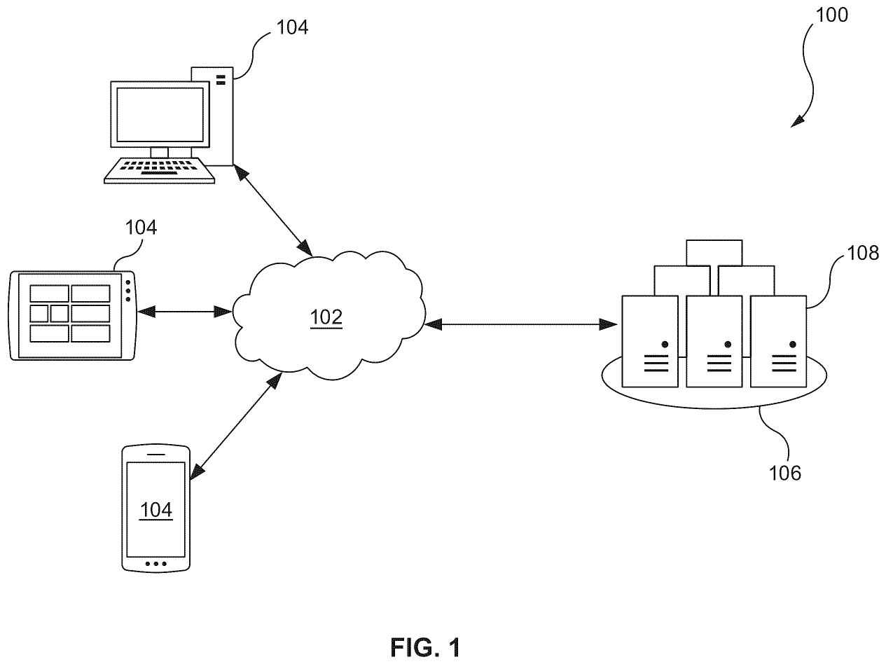

Referring now to FIG. 1, there is shown a computer network 100 that comprises an example embodiment of a system for processing medical diagnostic information. More particularly, the computer network 100 comprises a wide area network 102 such as the Internet to which various client devices 104 and data center 106 are communicatively coupled. The client devices 104 may be used by a clinician in furtherance of their medical practice, or by a billing agent who assists clinicians with their billing. The data center 106 comprises a number of servers 108 networked together to collectively perform various computing functions. For example, in the context of a medical practice, the data center 106 may host online services in support of a medical practice and permit users (e.g. physicians, dentists, optometrists, veterinarians or other clinicians) to log in to those servers using user accounts that give them access to various computer-implemented support services, such as electronic medical records and submission of billings to an insurer (which may be the government or a government agency, or a private insurer). While illustrative embodiments are described in the context of medical billing procedures, this is merely to provide an illustrative context showing one non-limiting application of methods for dynamically generating an LLM prompt for a rejection according to the present disclosure, and the methods are not limited or directed to medical billing applications.

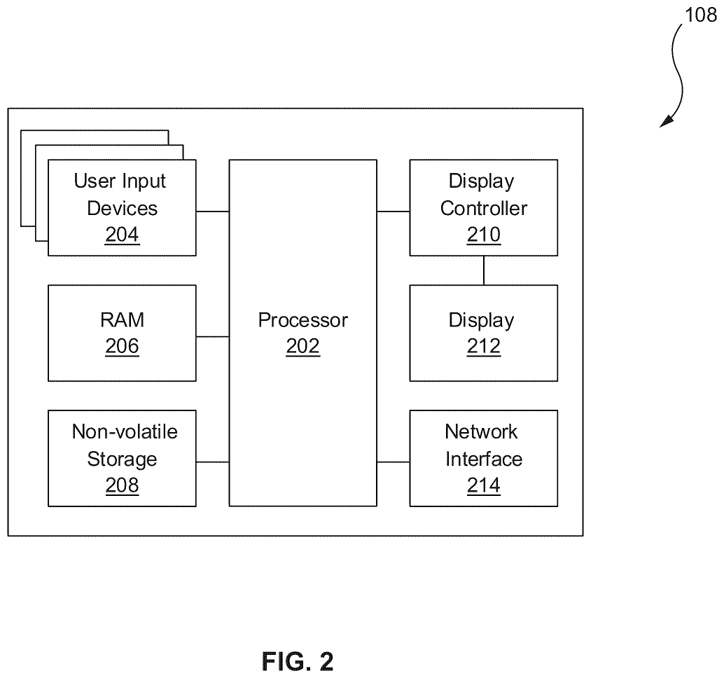

Referring now to FIG. 2, there is depicted an example embodiment of one of the servers 108 that comprises the data center 106. The server comprises a processor 202 that controls the overall operation of the server 108. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code executed by the RAM 206 at runtime; a display controller 210, which is communicatively coupled to and controls a display 212; and a network interface 214, which facilitates network communications with the wide area network 102 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement medical billing procedures such as is described in more detail below. Additionally or alternatively, the servers 108 may collectively perform that method using distributed computing. While the system depicted in FIG. 2 is described specifically in respect of one of the servers 108, analogous versions of the system may also be used for the client devices 104.

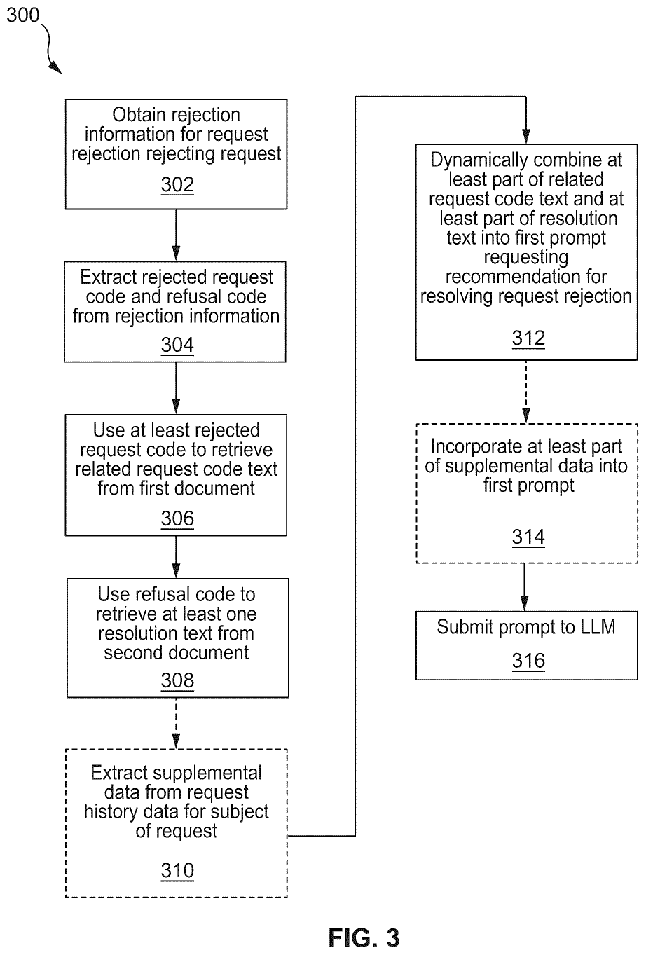

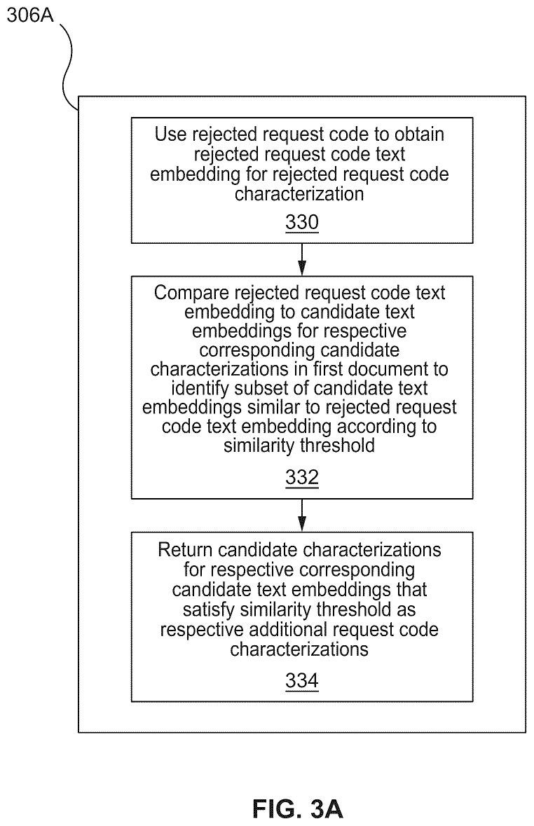

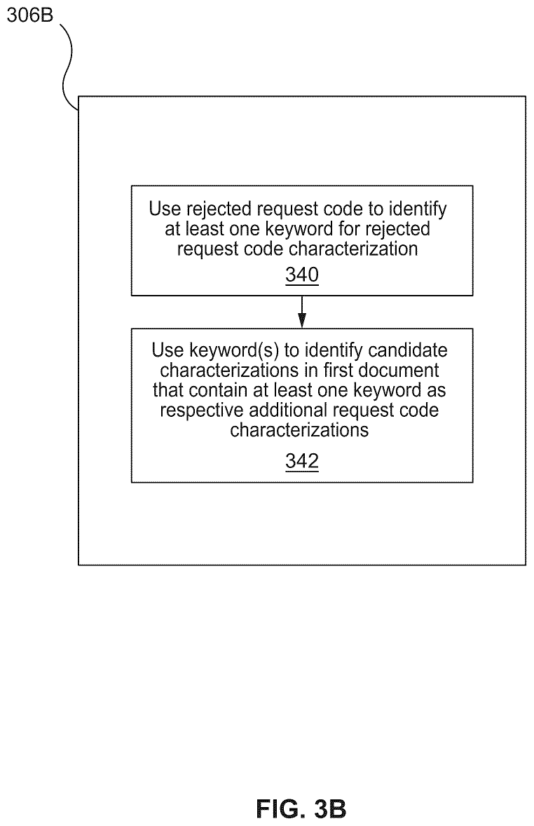

Reference is now made to FIG. 3, which shows a non-limiting illustrative embodiment of a method 300 for dynamically generating an LLM prompt for a rejected request. At step 302, the method 300 obtains rejection information for a request rejection rejecting a request (the rejected request). The rejected request may be, for example, an insurance claim, or a billing submission (e.g. an invoice), or a reimbursement request (e.g. by an employee seeking reimbursement for expenses incurred during business travel), or a request for authorization to undertake a particular activity (e.g. advance approval for business travel). The request rejection may be a complete or partial refusal of the request, for example, denial of all or part of an insurance claim or billing submission, denial of reimbursement or denial of a requested authorization. These are merely non-limiting, illustrative examples of requests and request rejections. Typically but not necessarily, the request and the request rejection are both electronic documents.

The rejection information obtained at step 302 comprises a rejected request code for the rejected request and a refusal code for the rejected request and may include additional information. The rejected request code may be a numeric or alphanumeric code, and is a code associated with the original request, for example, a billing code, insurance claim code, reimbursement code, or business reason code. The refusal code is an indication of the reason that the original request was rejected in the request rejection and may also be a numeric code or an alphanumeric code.

At step 304, the method 300 extracts, from the rejection information, the rejected request code and the refusal code. The extraction at step 304 may be carried out, for example, by locating predefined fields in the request rejection, or by parsing text in the request rejection and comparing the parsed text to a predefined list of request codes and refusal codes. These are merely non-limiting examples of extraction techniques.

At step 306, the method 300 uses at least the rejected request code to retrieve related request code text from a first document. In an insurance context, the first document may comprise, for example, a set of claim codes or billing codes with associated text. Where the rejected request is a claim (billing) submission under the Ontario Health Insurance Plan (OHIP), the first document may be the OHIP Schedule of Benefits (as defined below), which contains billing codes and characterizations (descriptive text and/or rules text). This is merely a non-limiting illustrative example. The related request code text retrieved at step 306 comprises a rejected request code characterization (descriptive text and/or rules text) for the rejected request code itself, as well as additional request codes that are related to the rejected request code and respective additional request code characterizations (descriptive text and rules text) for the additional request codes.

Additional request codes may be related to the rejected request code by, for example, proximity within the first document, symbolic similarity in the codes (where the code scheme is suitably organized) or symbolic and/or semantic similarity between the text in the first document associated with the rejected request code itself, and text in the first document associated with other request codes. The term “characterization”, as used in the context of a request code, includes descriptive text associated with the request code as well as rules text associated with the request code.

As noted above, in the context of health insurance, where health care providers such as physicians, dentists, optometrists, veterinarians or other clinicians submit claims (billing) to the insurer (which may be a private insurer or the government or a government agency) for services provided to a patient, the first document may be a “statement of benefits” setting out claim codes or billing codes for each procedure, along with a description of the procedure (descriptive text) and related information about when the claim or billing code may or may not be used (rules text). Thus, in the context of health insurance where health care providers bill the insurer, consider the following illustrative simplified fictional example of an extract from a fictional statement of benefits as a first document:

| Code | Description |
|---|---|
| A123 | Prenatal examination, first trimester, patient under 22 years old |
| A124 | Prenatal examination, first trimester, patient 22-35 years old |
| A125 | Prenatal examination, first trimester, patient over 35 years old |
| A223 | Prenatal examination, second trimester, patient under 22 years old |
| A224 | Prenatal examination, second trimester, patient 22-35 years old |
| A225 | Prenatal examination, second trimester, patient over 35 years old |
| A323 | Prenatal examination, third trimester, patient under 22 years old |
| A324 | Prenatal examination, third trimester, patient 22-35 years old |
| A325 | Prenatal examination, third trimester, patient over 35 years old |

In the above example, the entire description is the characterization, and the phrases “Prenatal examination, [first/second/third] trimester” are descriptive text (describing the nature of the procedure) and the phrases “[first/second/third] trimester, patient [under 22/23 to 35/over 35] years old” are rules text. Of note, there may be overlap between the descriptive text and the rules text.

Suppose that a physician used the billing code A223 in the request (e.g. claim), leading to a request rejection (e.g. claim refusal). In one embodiment, the related request code text retrieved at step 306 may include codes A123, A124, A125, A223, A224, A225, A323, A324, A325 and the respective description for each code from the statement of benefits as the first document. The additional request codes A123, A124, A125, A224, A225, A323, A324, A325 may be considered as being related to the rejected request code A223 for any one or more of the following reasons:
proximity within the first document (the additional request codes A123, A124, A125 precede the rejected request code A223 and the additional request codes A224, A225, A323, A324, A325 follow the rejected request code A223);
symbolic similarity in the codes (the additional request codes A123, A124, A125, A224, A225, A323, A324, A325 have the same leading character as the rejected request code A223 and differ from the rejected request code A223 by only one or two characters);
symbolic similarity between the text in the first document associated with the rejected request code itself, and text in the first document associated with other request codes (the text for the additional request codes A123, A124, A125, A224, A225, A323, A324, A325 differs symbolically from that for the rejected request code A223 only by the characters associated with the particular ages and trimesters); and
semantic similarity (including keyword matching) between the text in the first document associated with the rejected request code itself, and text in the first document associated with other request codes (the text for the additional request codes A123, A124, A125, A224, A225, A323, A324, A325 is semantically similar to that for the rejected request code A223 in that all relate to a prenatal exam for a particular trimester and particular age range);
text embedding similarity between the text in the first document associated with the rejected request code itself, and text in the first document associated with other request codes.

Reference is now made to FIG. 3A, which shows a first illustrative non-limiting method 306A for using (at least) the rejected request code to retrieve the related request code text from the first document, which is one possible implementation of step 306 of the method 300 shown in FIG. 3. At step 330, the method 306A uses the rejected request code to obtain a rejected request code text embedding for the rejected request code characterization. At step 332, the method 306A compares the rejected request code text embedding to candidate text embeddings for respective corresponding candidate characterizations in the first document (for example, the rest of the statement of benefits in a health insurance context) to identify a subset of the candidate text embeddings that are similar to the rejected request code text embedding according to a similarity threshold. This may be, for example, a vector similarity threshold, including but not limited to cosine similarity. Then, at step 334, the method 306A returns those of the candidate characterizations for which the respective corresponding candidate text embeddings satisfy the similarity threshold as the respective additional request code characterizations.

Reference is now made to FIG. 3B, which shows a second illustrative non-limiting method 306B for using the rejected request code to retrieve the related request code text from the first document. The method 306B is another possible implementation of step 306 of the method 300 shown in FIG. 3. At step 340, the method 306B uses the rejected request code to identify at least one keyword for the rejected request code characterization, and then at step 342, the method 306B uses the keyword(s) to identify, as the respective additional request code characterizations, those ones of the candidate characterizations in the first document that contain at least one of the keyword(s). For example, for the illustrative simplified fictional example noted above, the keywords may be “prenatal” and “trimester”. Keyword searching may use any etymological technique, including without limitation techniques such as truncation and word roots.

It is also contemplated that using the rejected request code to retrieve the related request code text from the first document at step 306 (FIG. 3) may comprise both the method 306A (text embedding comparison) and the method 306B (keyword comparison), i.e. a “hybrid search”, and may alternatively or additionally comprise other techniques.

It is possible to use additional information, beyond solely the rejected request code, to retrieve additional request codes and the respective additional request code characterizations. In one non-limiting embodiment, payment rules may be used in addition to the rejected request code to retrieve additional request codes and the respective additional request code characterizations. In one non-limiting example, the rejection information may indicate a payment rule that the rejected request cannot be billed in combination with another procedure. Even if the other procedure is not mentioned in the request code characterization for the rejected request, the payment rule can be leveraged to identify additional request codes that are related to the rejected request code through the payment rule. For example, the request code characterization for the rejected request may not use the word “prenatal”, but if a payment rule stated “cannot be billed with prenatal examination”, the payment rule could be used to identify additional request codes whose respective additional request code characterizations include the word “prenatal”.

Returning to FIG. 3, at step 308 the method 300 uses the refusal code to retrieve at least one resolution text from a second document. The second document may be, for example, claim resolution documentation or billing resolution documentation, and the resolution text(s) may comprise a description of a claim problem or billing problem and a recommended resolution. In a health insurance context, claim resolution documentation may be internal notes compiled from operational knowledge and experience of staff at the health care provider, or at a third party agent that assists with submitting claims or billing. Vector embedding need not be used in respect of step 308. In one embodiment, the refusal code, retrieved from the rejection information, may be used to retrieve a description and solution for the refusal code from a comma separated value (CSV) file that maps each refusal code to a solution.

At optional step 310, the method 300 extracts supplemental data from request history data for a subject of the request. The supplemental data preferably includes at least one of supplemental request codes (e.g. previous codes that have been billed) and supplemental refusal codes, and may include dates of service, diagnosis, and other data. In a health insurance context, the subject of the request may be the patient, or the provider (e.g. physician, dentist, optometrist, veterinarian or other clinician), or a provider-patient pair, and the supplemental data may come from a claim history and/or billing history for that patient, that provider, or that provider-patient pair. There may be previous requests that provide context to the current request rejection. For example, where a pediatrician is treating twins, there may be a history in which claims have been refused because of transposition of information from one twin to the other. This is merely one non-limiting, illustrative example. Thus, historical, relevant data may be captured at optional step 310.

At step 312, the method 300 dynamically combines at least part of the related request code text from step 306 and at least part of the resolution text from step 308 into a first prompt requesting a recommendation for resolving the request rejection. At optional step 314, which is implemented if optional step 310 is performed, the method 300 incorporates at least part of the supplemental data from optional step 310 into the first prompt. Although shown sequentially for purposes of illustration, where optional step 314 is present, steps 312 and 314 may be combined into a single step.

In a preferred embodiment, dynamically combining at least part of the related request code text from step 306 and at least part of the resolution text from step 308 into the first prompt uses few-shot prompting. Few-shot prompting is a prompt engineering technique in which information is included within the prompt to support in-context learning so as to guide the LLM to better performance in responding to the prompt. In a particularly preferred embodiment, the first prompt comprises a populated copy of a template. The template includes an identifier of a persona to be adopted by the LLM and a resolution request for the request rejection, and the copy of the template is populated by enriching the resolution request with at least part of the related request code text from step 306 and at least part of the resolution text from step 308. Optionally, the first prompt may further comprise a prefix specifying a format of a response for the LLM; in such an embodiment the format preferably comprises a menu of options for resolving the request rejection.

In one embodiment, the template for the first prompt defines three role types:
1. System: Outlines the “persona” of the assistant, the expected response, formatting, restrictions, and definitions.
2. User: Asks “How do I resolve the current request rejection?” and enriches the query with the related request code text from step 306, at least part of the resolution text from step 308, and (where optional step 310 is performed) at least part of the supplemental data from optional step 310.
3. Assistant: Provides context for the claim's rejection, including relevant payment rules violated, and the definition of the refusal code. It cites the specific field in the current claim that contributed to the rejection, includes evidence from historical claims if relevant, offers to make the required change on the user's behalf, and preferably presents a menu of actions for the user to choose from.

The template for the first prompt preferably includes several examples of user/assistant queries and responses to influence the format of the returned response.

Then, at step 316, the method 300 submits the prompt to an LLM.

Thus, in a preferred embodiment, in addition to the rejected request code and the refusal code extracted at step 304, the prompt is enriched not only with related request code text from step 306 but also the resolution text(s) from step 308, which provides additional information, rules and context for the refusal code extracted at step 304. If the prompt contained only the rejected request code, or only the rejected request code and the refusal code, the LLM would likely be able to verify that the rejection was justified but would be unlikely to be able to provide additional guidance. The related request code text from step 306 may provide additional context for the LLM to, for example, suggest changing the rejected request code to one of the related request codes.

Returning to the illustrative simplified fictional example noted above, the rejected request code may have been A123 for “Prenatal examination, first trimester, patient under 22 years old” but the patient was age 23 so the correct request code should have been A124. Without the additional context provided by the related request code text from step 306, the LLM might not be able to identify a correction, but with this additional context may be able to suggest changing the request code from A123 to A124 to overcome the request rejection.

Thus, a copy of a first few-shot prompt template is populated to combine multiple data insights in order to foster an improved response. In a health insurance context, these data insights include related request code text (e.g. billing code information and payment rules) from a first document (e.g. a statement of benefits) obtained at step 306, at least one resolution text from a second document (e.g. internal medical billing resolution notes compiled from operational and tacit knowledge of experienced billing agents) at step 308, and optionally at least part of the supplemental data from the request history data for a subject of the request (e.g. historical, relevant claims data concerning the provider and/or patient) obtained at optional step 310. The first few-shot prompt template also includes specifications for the response from the LLM, such as response restrictions, definitions, and format.

In one embodiment, the response returned from the LLM may contain information divided into two parts:
1. Information about the rejected request code (e.g. claim code or billing code), the refusal code, possible reasons for the request rejection (which may reference parts of the rejected request), and a suggested action.
2. A small number (e.g. two to four) of follow-up prompts based on the possible reasons for the request rejection, which may include accepting/rejecting modification of a field in the rejected request or learning more about the rejected request code. These prompts may be presented in a menu.

If the user accepts the suggestion, a second prompt may be generated. The second prompt may also be a few-shot prompt, and may be generated from a second template. The second template may be formatted with the relevant information gathered from the previous steps and engineered to retrieve a command, for example an SQL command, to modify one or more fields in the rejected request.

In one embodiment, the template for the second prompt also defines three role types:
1. System: Outlines the “persona” of the assistant, the database schema, definitions of a claim fix or claim cancellation, the expected response and formatting.
2. User: Prompt based on the intended claim fix (e.g. “Change the billing code to A124” or “Update the claim status to rejected”).
3. Assistant: Provides the command (e.g. SQL command) to modify the rejected request.

For example, where a user has selected one of the follow-up prompts that requires a change to the rejected request (e.g. a billing code change, status change, or a claim cancellation), another few-shot prompt template is generated and sent to the LLM, and used to form a command to effect the change (e.g. an SQL command that fulfills the request in the database via SQLAlchemy ORM). Thus, the rejected request can be updated in real time.

Aspects of an illustrative, non-limiting technical implementation will now be described in the context of the Schedule of Benefits: Physician Services, which at the time of filing is a schedule under Regulation 552 (R.R.O. 1990, Reg. 552) of the Ontario Health Insurance Act, R. S. O. 1990, c. H.6, with the exception of the Table of Contents, Appendices A, B, C, F, G, H, Q, and the Numeric Index and is referred to herein as the “OHIP Schedule of Benefits” for brevity. The version of the OHIP Schedule of Benefits dated Feb. 14, 2025 and effective Mar. 3, 2025 was published at https://www.ontario.ca/files/2025-03/moh-schedule-benefit-2024-03-04.pdf and may be updated from time to time.

In a non-limiting, illustrative embodiment, the OHIP Schedule of Benefits is notionally divided into chapter-content specific sections, and then embeddings are generated for the document. Without being limited by theory, and without promising any particular utility, splitting and chunking the document and then sending multiple rounds of embeddings supports proper storage of the embeddings.

Where the OHIP Schedule of Benefits is provided in Portable Document Format (PDF), text retrieval may be achieved, for example, using PyPDF (https://pypi.org/project/PyPDF2/); this is merely an illustrative embodiment and is not limiting, and any suitable PDF reader may be used. PyPDF enables the extraction of text to create a data frame which provides more granularity in generating and controlling chunk size and overlap for generating embeddings.

An illustrative, non-limiting chunking strategy is to notionally divide the OHIP Schedule of Benefits into chunks of 512 tokens, with a 20% (103 token) overlap and with a token having an average of 4 characters. The data frame currently contains two columns, the content and page number, but is highly modifiable per the document's requirements. In a preferred embodiment, the first document (e.g. OHIP Schedule of Benefits) is divided into context-relevant and section-relevant chunks to generate the embeddings.

Vector embedding generation may be achieved by taking the data frame chunks (which can be swapped for a document file type to provide increased granularity for the developer) and using the ada-002 text embedding (https://platform.openai.com/docs/guides/embeddings), following the OpenAI specification, with a 1536 dimensionality. This is merely illustrative and not limiting, and can be modified to change the detail captured or the compression of the embedding generation. In addition, by creating a data frame, additional metadata details can be generated, such as adding page numbers, or even important request codes (e.g. claim/billing codes) for each chunk to enhance retrieval.

After the embeddings have been generated, in an illustrative embodiment an instance of PostgreSQL is used to store these vectors and provide querying and response capabilities across users, rather than a local memory store (which stores embeddings within a single session in memory for a single user) as is commonly used with RAG implementations. SQLAlchemy Object Relational Mapper (ORM) (https://www.sqlalchemy.org/) is used to create a standardized PostgreSQL connection, which can be modified for a local or remote database and vector store. SQLAlchemy ORM allows the embeddings to be stored onto PostgreSQL, either in a new or pre-existing table. This enables rapid retrieval of embeddings compared to a local memory store.

Using PostgreSQL as a vector store, step 306 (more particularly, the embodiment of step 306 represented by the method 306A in FIG. 3A) may be implemented as follows. A query (e.g. rejected request code and/or rejected request code characterization) is embedded into vectors, and these vectors can then be used to retrieve the most relevant vectors (e.g. additional request code characterizations for additional request codes that are related to the rejected request code). Retrieval may be based on vector similarity, for example cosine similarity, although other retrieval strategies may be used. Preferably, cosine similarity is used with the ada-002 embedding for accuracy. A custom query that incorporates the request code (e.g. claim/billing code), patient diagnosis, and optionally provider specialty is embedded using the ada-002 model and compared to vector embeddings stored in a pgvector database (a PostgreSQL extension) for vector search; see https://www.postgresql.org/about/news/pgvector-050-released-2700/) using cosine similarity. After using cosine similarity to return the most relevant source materials for a query, the k-nearest neighbors (KNN) retrieval strategy is used to return the most relevant chunks to the model. In the illustrated embodiment, the three most relevant chunks are returned but in other embodiments more or fewer chunks may be returned. The results may be sent to an OpenAI Question-Answering retriever chain, which uses a suitable version of GPT offered by OpenAI, LLC having an address at 1455 3rd Street, San Francisco, California 94158. This can be changed depending on the implementation details; the systems, methods and computer program products of the present disclosure are not limited to any particular LLM. The OpenAI Question-Answering retriever chain then returns a response used to provide further context for the request code (e.g. claim/billing code) and contains payment rules that may have been violated or an alternative request code that should have been used instead.

Using PostgreSQL, keyword searching may be enabled for step 306 (more particularly, the embodiment of step 306 represented by the method 306B in FIG. 3B) using TSvector, a built-in function in PostgreSQL to enable keyword search; see: https://www.postgresql.org/docs/16/datatype-textsearch.html#DATATYPE-TSVECTOR.

The results from step 306 (based on the most relevant vectors or keyword results) are combined with the resolution text(s) from the second document (e.g. claim/billing resolution documentation) from step 308, and optionally with at least part of the data from the request history data (e.g. claim history and/or billing history) for the subject of the request from optional step 310, into the prompt at step 312 (and optional step 314).

In a preferred embodiment, source retrieval and citation is provided by leveraging the metadata generated during the embedding creation stage. When the response is generated using specific source documents (e.g. the OHIP Schedule of Benefits), the metadata is retained and the source used can be returned, allowing determination of the original source of the content, enabling developers to detect errors within the RAG implementation process when a faulty response is captured. This supports a reduction in hallucination and invalid response data, and in a preferred embodiment the system is monitored for hallucinations on an ongoing basis. An additional benefit of the chunking and vector embedding techniques described herein is to support directed queries of the first document (e.g. a schedule of benefits in an insurance context, or reimbursement rules for a business).

The chunking and embedding features can also support a querying tool to leverage and surface knowledge of the first document. For example, the OHIP Schedule of Benefits is (at time of filing) a document of nearly one thousand pages, specifying the rules, available procedures and payable amount for every procedure that the Ontario Ministry of Health recognizes, and the format varies through the document. The RAG methodology (supported by the chunking and embedding features and/or keyword searching) enables effective queries against this document using an LLM.

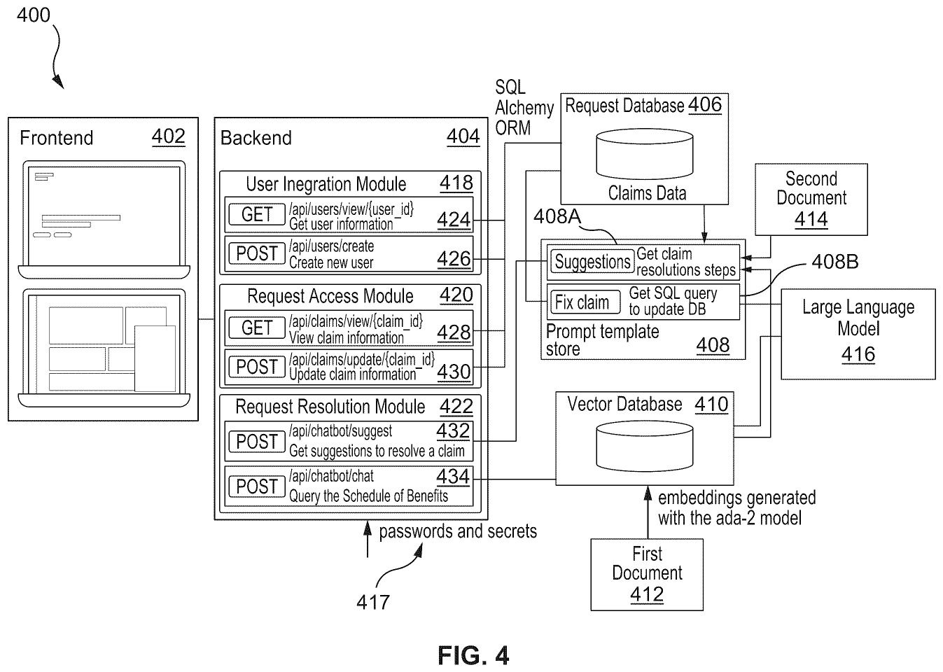

Reference is now made to FIG. 4, which is an illustrative, non-limiting architecture diagram for a system 400 implementing aspects of the technology described herein in the context of billings/claims under a health insurance program, for example OHIP as described above.

The system 400 comprises a frontend 402, a backend 404, a request database 406 (e.g. a billing/claim database), a prompt template store 408, a vector database 410 storing a first document 412 (e.g. schedule of benefits) and a second document 414 (e.g. claim/billing resolution documentation). An LLM 416 may form part of the system 400 or may be provided by a third party on a separate computer system (e.g. a ChatGPT implementation or another suitable third party LLM).

The frontend 402 provides a user interface to the backend 404, and in the illustrated embodiment is implemented using next.js (https://nextjs.org/). The frontend 402 can present information about the rejected request, and allows an end user to view all relevant aspects of the request. For example, the frontend 402 may allow a user to view a history of previous interactions, and save (and later view) previous requests and other information for future reference.

The backend 404 is, in the illustrated embodiment, implemented using Flask (https://flask.palletsprojects.com/en/3.0.x/) and JSON Web Tokens (https://jwt.io/introduction and https://www.jwt.io/libraries). The request database 406 and the vector database 410 are implemented using PostgreSQL (https://www.postgresql.org/) with the vector database further implementing pgvector. Thus, the vector database 410 comprises a PostgreSQL database and a pgvector database. LangChain (https://www.langchain.com/) may be used for interaction with the LLM 416. Credentials 417 (e.g. passwords) may be managed, for example, using HashiCorp Vault (https://www.hashicorp.com/products/vault). Each of the foregoing is merely a non-limiting, illustrative example. The first document 412 is stored as text embeddings in the vector database 410, and the second document 414 is stored in CSV format, and may be stored in the prompt template store or in another suitable data store. The prompt template store stores a request resolution suggestion prompt template 408A and a request correction prompt template 408B. In a preferred embodiment, the backend 404 deploys a web scraper that checks for updates to the first document (e.g. statement of benefits) on the relevant website and makes incremental updates to the existing vector embeddings in the vector database 410 without regenerating them. A web scraper would only be deployed where permitted by law and by the relevant terms of service, if any.

The backend 404 supports a user integration module 418, a request access module 420 and a request resolution module 422. The user integration module 418 supports a user information GET operation 424 to retrieve user information and a new user POST operation 426 to add a new user to the system 400. The request access module 420 supports a request retrieval GET operation 428 to retrieve information about a request (e.g. claim/billing) and a request update POST operation 430 to add a new request to the system 400 or to update an existing request. In the illustrated embodiment, the user information GET operation 424, new user POST operation 426, request retrieval GET operation 428 and a new request POST operation are implemented via SQLAlchemy ORM interaction with the request database 406.

The request resolution module 422 supports a rejection resolution POST operation 432 and a document query POST operation 434, and may in some embodiments be implemented as a “chatbot”. The rejection resolution POST operation 432 initiates the procedure described above in the context of FIG. 3 to populate a copy of the request resolution suggestion prompt template 408A with information from the request database 406, the vector database 410 (storing embeddings from the first document 412) and the second document 414. Information returned from the LLM 416 is then presented to the user via the frontend 402, allowing the user to select the next step. If the user elects to make (one of) the suggested correction(s), a copy of the request correction prompt template 408B is populated based on the election to obtain the required SQL command, and the request update POST operation 430 is triggered to send the SQL command to the request database 406 to update the request. The document query POST operation 434 engages a querying tool for the first document 412 (e.g. a statement of benefits).

In preferred embodiments, API endpoints are protected by using JSON Web Tokens (JWT) to authenticate users. In addition, in preferred embodiments, robust protections are deployed to protect personally identifying information (PII) and personal health information (PHI) to maintain compliance with all applicable legislation and regulations. For example, the system 400 is preferably configured to avoid transmission of any PII or PHI to an external LLM, and to ensure that any sample information contains only fictionalized data. Endpoint security may be used to check for and prevent the transmission or collection of PII or PHI.

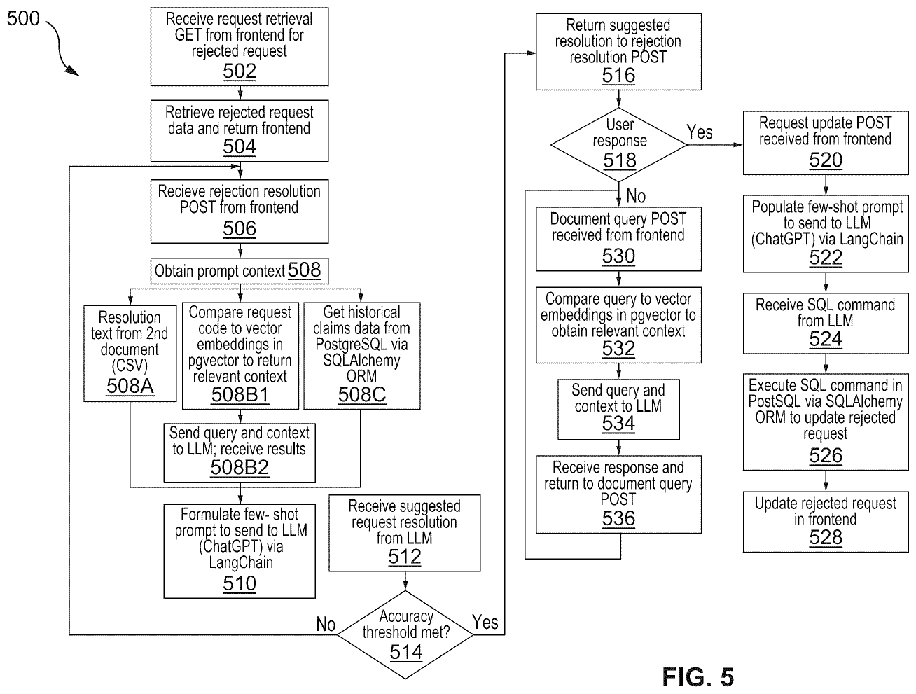

Reference is now made to FIG. 5, which is a flow chart showing an illustrative process flow 500 for the backend 404 of the illustrative system 400 shown in FIG. 4.

At step 502, the method 500 receives a request retrieval GET (request retrieval GET operation 428 in FIG. 4) for a rejected request and at step 504 the method 500 retrieves the rejected request data for the rejected request and returns it to the frontend 402 (FIG. 4). The rejected request data for the rejected request comprises the original rejected request and optionally the associated rejection information. At step 506, the method 500 receives a rejection resolution POST (rejection resolution POST operation 432 in FIG. 4) and then at step 508 obtains context information to populate the copy of the first prompt template (request resolution suggestion prompt template 408A). In one embodiment, an API call via Flask, containing the current claim information in the request rejection, is sent to the backend 404 to retrieve the relevant information, and in the illustrated embodiment step 508 is implemented by a plurality of sub-steps, which may proceed in parallel or in sequence in any order. At step 508A, the method 500 obtains the resolution text(s) from the second document by accessing the CSV file. At step 508B1, the method 500 compares the request code for the rejected request to the vector embeddings in pgvector in the vector database 410 (FIG. 4) to obtain the relevant context, and at step 508B2 the method 500 sends a query with the context to the LLM 416 (FIG. 4) and receives the results. At step 508C, the method 500 obtains the supplemental data (e.g. historical billing/claims data) by accessing the vector database 410 (FIG. 4) using PostgreSQL via SQLAlchemy ORM. In one embodiment of step 508C, using the information returned in the request rejection, an SQL query is formulated to identify recent similar claims submitted by the same provider and/or patient, and using SQLAlchemy ORM, an API call is made to the PostgreSQL database to retrieve the results of the SQL query. In one embodiment, the request rejection comprises a message body in JavaScript Object Notation (JSON) format containing unique identifiers for the claim, which may include an identifier for the provider and an identifier for the patient.

At step 510, the method 500 uses the results from steps 508A, 508B1 and 508B2, and 508C, to populate a copy of the request resolution suggestion prompt template 408A (FIG. 4) and thereby formulate a few-shot prompt to send to the LLM 416 (FIG. 4), which in the illustrative embodiment is a ChatGPT implementation, via LangChain. Again, other LLMs may be used.

At step 512, the method 500 receives a suggested request resolution from the LLM 416 (FIG. 4) and applies an optional accuracy threshold test 514. If the suggested request resolution fails the accuracy threshold test (“no” at step 514), the method 500 returns to step 506. If the suggested request resolution passes the accuracy threshold test (“yes” at step 514), the method 500 proceeds to step 516 and returns the suggested resolution to the rejection resolution POST (rejection resolution POST operation 432 in FIG. 4) and awaits a user response at step 518. In a preferred embodiment, the suggested request resolution is presented via streaming using FastAPI's StreamingResponse (https://fastapi.tiangolo.com/advanced/custom-response/#streamingresponse) so the suggested request resolution is presented to the user chunk by chunk, instead of the user having to wait for the entire response to be generated before it is rendered on the frontend 402 (FIG. 4).

If the user elects to accept the suggested resolution from the LLM (“yes” at step 518), then at step 520 the method 500 will receive a request update POST (request update POST operation 430 in FIG. 4) from the frontend 402 (FIG. 4) and proceed to step 522.

At step 522, the method 500 populates a copy of the request correction prompt template 408B (FIG. 4) and thereby formulates a few-shot prompt to send to the LLM 416 (FIG. 4), which in the illustrative embodiment is a ChatGPT implementation although other LLMs may be used, via LangChain, and at step 524 receives the appropriate SQL command from the LLM 416 (FIG. 4). At step 526, the method 500 executes the SQL command in PostgreSQL via SQLAlchemy ORM to update the rejected request. Using SQLAlchemy ORM, an API call is made to the PostgreSQL database (request database 406 in FIG. 4). Step 526 may be implemented using the request update POST operation 430 (FIG. 4). The method 500 then updates the rejected request in the frontend 402 (FIG. 4) at step 528.

If the user elects to decline the suggested resolution from the LLM (“no” at step 518) then at step 530 the method 500 will receive a document query POST (document query POST operation 434 in FIG. 4) from the frontend 402 (FIG. 4) and proceed to step 532. This indicates that the user wishes to explore the first document (e.g. statement of benefits) and attempt to find a resolution on their own.

At step 532, the method 500 compares embeddings for the query embodied in the document query POST (step 532) to the vector embeddings in the pgvector database (in the vector database 410 in FIG. 4) to obtain the relevant context. Then, at step 534 the method 500 sends the query and the relevant context to the LLM, and at step 534 the method 500 receives the response and returns it to the document query POST (document query POST operation 434 in FIG. 4).

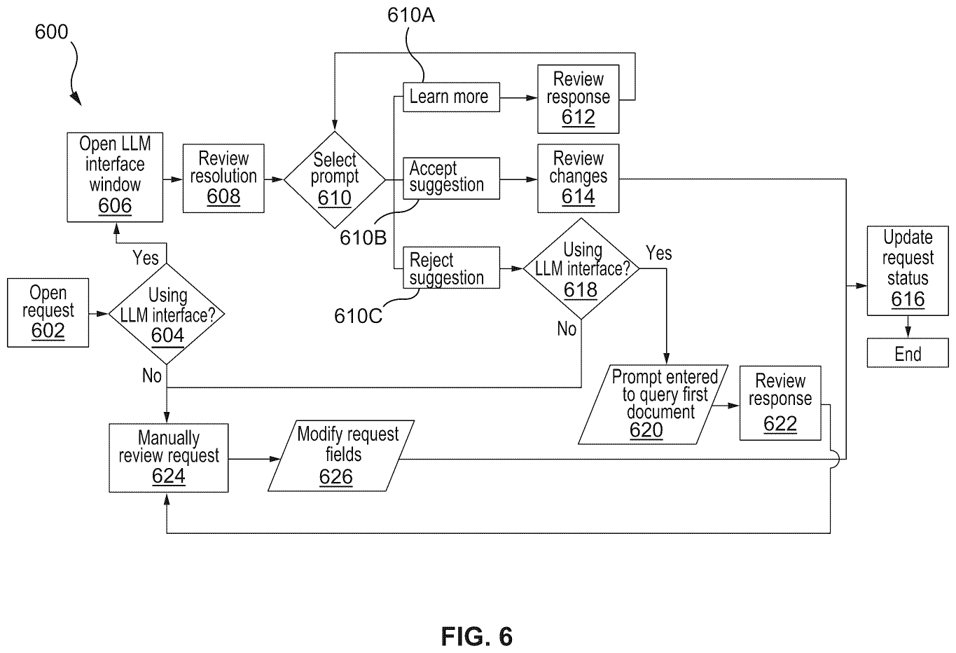

Reference is now made to FIG. 6, which is a flow chart showing an illustrative user flow 600 for a user of the system 400 shown in FIG. 4.

At step 602, the user opens a rejected request (e.g. a billing or claim submission that has been denied). This corresponds to steps 502 and 504 in FIG. 5. At step 604, the user decides whether to use the LLM interface. If the user decides to use the LLM interface (“yes” at step 604), the user proceeds to step 606, which opens the LLM interface window, and then to step 608 where the user is presented with a recommended resolution to review. Step 606 in FIG. 6 corresponds to step 506 in FIG. 5, and step 608 presents the user with the results of steps 508 through 516 in FIG. 5. At step 610, the user can select a prompt to either “Learn More” 610A, “Accept Suggestion” 610B, or “Reject Suggestion” 610C. This corresponds to step 518 in FIG. 5. If the user selects “Learn More” 610A, the user proceeds to step 612 to review the response (e.g. an explanation of the recommended resolution) and returns to step 610. If the user selects “Accept Suggestion” 610B, the user proceeds to step 614 to review the changes and after an optional confirmation step (not shown) the user proceeds to step 616 to see that the request (e.g. a billing or claim submission) has been updated. If the user selects “Reject Suggestion” 610C, the user proceeds to step 618, where the user is given the opportunity to opt out of the LLM interface. If the user elects to remain within the LLM interface (“yes” at step 618), the user proceeds to step 620, where the user enters a custom prompt to query the first document (e.g. statement of benefits). Step 620 in FIG. 6 corresponds to step 530 in FIG. 5. After step 620, the user proceeds to step 622 to review the response to the query from step 620. Step 622 presents the user with the results of steps 532 through 536 in FIG. 5. After step 622, the user proceeds to step 624 to manually review the rejected request, and then to step 626 to modify one or more fields in the rejected request. From step 626, the user proceeds to step 616 to see that the request (e.g. a billing or claim submission) has been updated.

If the user declines to use the LLM interface (“no” at step 604) or exits the LLM interface after the user selects “Reject Suggestion” 610C (“no” at step 618), the user proceeds directly to step 624 to manually review the request.

Note that “End” in FIG. 6 denotes only the end of this particular aspect of the user interaction, and not necessarily the end of the entire user interaction.

In the context of a system that supports claims/billing under a health insurance program, the end user may be a provider (e.g. a physician, dentist, optometrist, veterinarian or other clinician, or a hospital, clinic, etc.), or another party employed by a provider, such as a billing clerk, or an employee or agent of a third party entity that assists providers with billing. Medical billing can be a complicated process in Canada and the United States. In Canada, each province has complex guidelines when it comes to physicians being paid for their services. Private and government insurers in the United States may also have complex rules for payment, and there may be similar requirements for dental insurance and health insurance for animals.

In the Canadian context, the Dr. Bill® platform is a medical billing platform that streamlines the billing process for Canadian physicians. When physicians registered with the Dr. Bill® platform perform a service on a patient, they submit a claim through the Dr. Bill® platform, which is then sent to the relevant government agency (e.g. Ontario Ministry of Health). Depending on whether the claim is accepted or rejected, the government agency would provide or withhold compensation to the physician for the service provided. Claims where compensation is withheld can be modified and resubmitted to adhere to the requirements for physician compensation. Thus, systems, methods and computer program products according to an aspect of the present disclosure may be applied in the context of a medical billing platform, although they are by no means limited to this context. Moreover, when integrated into a medical billing platform, it is also contemplated that systems, methods and computer program products according to an aspect of the present disclosure may be adapted to predict whether a claim may be rejected before it is submitted and suggest modifications in advance of submission. Medical billing platforms represent merely a representative context in which systems, methods and computer program products according an aspect of the present disclosure may be applied, and have been used for purposes of illustration and without any limitation.

As can be seen from the above description, the dynamic prompt generation described herein represents significantly more than merely using categories to organize, store and transmit information and organizing information through mathematical correlations. The dynamic prompt generation is in fact an improvement to the technology of large language models, because it allows for automatic generation of relatively more effective prompts and improved results by incorporating “ground truth” information from a first document and human insight from a second document, neither of which were necessarily included in the training corpus, to improve the performance of an LLM. As such, the dynamic prompt generation technology is confined to large language models, and particularly to prompt engineering for large language models. Thus, the present disclosure is directed to the resolution of a computer problem, specifically the improvement of LLM performance in the context of queries relating to overcoming request rejections. Key features of the present disclosure describe and enable automation of the prompt generation process, which obviates the requirement for mental processes involved in manually constructing individual prompts for each request rejection. Importantly, however, the present disclosure is not directed merely to the automation of a manual process by generic computer processing of manual calculations, but describes specific functional computer technology that enables the automation of the prompt generation by a novel and inventive application of RAG to dynamically generate prompts for seeking LLM guidance in overcoming rejection requests. Furthermore, the human mind is not equipped to implement an LLM or RAG; submission of prompts to, and the generation of results by, an LLM are activities that are unique to computers and by their very nature require computer implementation-they exist only in the context of a computer system.

The present technology may be embodied within a system, a method, a computer program product or any combination thereof. The computer program product may include a computer readable storage medium or media having computer readable program instructions thereon for causing a processor to carry out aspects of the present technology. The computer readable storage medium can be a tangible, non-transitory device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object oriented programming language or a conventional procedural programming language. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to implement aspects of the present technology.

Aspects of the present technology have been described above with reference to flowchart illustrations and/or block diagrams of methods, apparatus (systems) and computer program products according to various embodiments. In this regard, the flowchart and block diagrams in the Figures illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Some specific examples of the foregoing may have been noted above but any such noted examples are not necessarily the only such examples. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, other programmable data processing apparatus, or other devices to function in a particular manner, such that the instructions stored in the computer readable storage medium produce an article of manufacture including instructions which implement aspects of the functions/acts specified in the flowchart and/or block diagram block or blocks. The computer readable program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the form disclosed. Many modifications and variations will be apparent to those of ordinary skill in the art without departing from the scope of the claims. The embodiment was chosen and described in order to best explain the principles of the technology and the practical application, and to enable others of ordinary skill in the art to understand the technology for various embodiments with various modifications as are suited to the particular use contemplated.

One or more currently preferred embodiments have been described by way of example. It will be apparent to persons skilled in the art that a number of variations and modifications can be made without departing from the scope of the claims. In construing the claims, it is to be understood that the use of a computer to implement the embodiments described herein is essential.

What is claimed is:

1. A computer-implemented method for dynamically generating a large language model (LLM) prompt for a rejected request, the method comprising:
obtaining rejection information for a request rejection for the rejected request, the rejection information comprising:
a rejected request code for the rejected request; and
a refusal code for the rejected request;
extracting, from the rejection information, the rejected request code and the refusal code;
using at least the rejected request code to retrieve related request code text from a first document;
wherein the related request code text comprises:
a rejected request code characterization for the rejected request code itself; and
additional request codes that are related to the rejected request code and respective additional request code characterizations for the additional request codes;
using the refusal code to retrieve at least one resolution text from a second document;
dynamically combining at least part of the related request code text and at least part of the resolution text into a prompt requesting a recommendation for resolving the request rejection; and
submitting the prompt to an LLM.

2. The method of claim 1, wherein using at least the rejected request code to retrieve the related request code text from the first document comprises:
using the rejected request code to obtain a rejected request code text embedding for the rejected request code characterization;
comparing the rejected request code text embedding to candidate text embeddings for respective corresponding candidate characterizations in the first document to identify a subset of the candidate text embeddings that are similar to the rejected request code text embedding according to a similarity threshold; and
returning, as the respective additional request code characterizations, those of the candidate characterizations for which the respective corresponding candidate text embeddings satisfy the similarity threshold.

3. The method of claim 2, wherein the similarity threshold is a vector similarity threshold.

4. The method of claim 1, further comprising;
extracting supplemental data from request history data for a subject of the request; and
before submitting the prompt to the LLM, incorporating at least part of the supplemental data into the prompt.

5. The method of claim 4, wherein the supplemental data includes at least one of supplemental request codes and supplemental refusal codes.

6. The method of claim 1, wherein dynamically combining at least part of the related request code text and at least part of the resolution text into the prompt uses few-shot prompting.

7. The method of claim 1, wherein the prompt comprises a populated copy of a template, wherein the template comprises:
an identifier of a persona to be adopted by the LLM; and
a resolution request for the request rejection;
wherein the copy of the template is populated by enriching the resolution request with the at least part of the related request code text and the at least part of the resolution text.

8. The method of claim 1, wherein the prompt further comprises a prefix specifying a format of a response for the LLM.

9. The method of claim 8, wherein the format comprises a menu of options.

10. The method of claim 1, wherein using at least the rejected request code to retrieve the related request code text from the first document comprises:
using the rejected request code to identify at least one keyword for the rejected request code characterization; and
using the at least one keyword to identify, as the respective additional request code characterizations, those ones of candidate characterizations in the first document that contain at least one of the at least one keyword.

11. A computer program product comprising at least one tangible, non-transitory computer readable medium embodying instructions which, when executed by at least one processor of a data processing system, cause the data processing system to implement a method comprising:
obtaining rejection information for a request rejection for the rejected request, the rejection information comprising:
a rejected request code for the rejected request; and
a refusal code for the rejected request;
extracting, from the rejection information, the rejected request code and the refusal code;
using at least the rejected request code to retrieve related request code text from a first document;
wherein the related request code text comprises:
a rejected request code characterization for the rejected request code itself; and
additional request codes that are related to the rejected request code and respective additional request code characterizations for the additional request codes;
using the refusal code to retrieve at least one resolution text from a second document;
dynamically combining at least part of the related request code text and at least part of the resolution text into a prompt requesting a recommendation for resolving the request rejection; and
submitting the prompt to an LLM.

12. The computer program product of claim 11, wherein using at least the rejected request code to retrieve the related request code text from the first document comprises:
using the rejected request code to obtain a rejected request code text embedding for the rejected request code characterization;
comparing the rejected request code text embedding to candidate text embeddings for respective corresponding candidate characterizations in the first document to identify a subset of the candidate text embeddings that are similar to the rejected request code text embedding according to a similarity threshold; and
returning, as the respective additional request code characterizations, those of the candidate characterizations for which the respective corresponding candidate text embeddings satisfy the similarity threshold.

13. The computer program product of claim 11, wherein the method further comprises;
extracting supplemental data from request history data for a subject of the request; and
before submitting the prompt to the LLM, incorporating at least part of the supplemental data into the prompt.

14. The computer program product of claim 11, wherein the prompt comprises a populated copy of a template, wherein the template comprises:
an identifier of a persona to be adopted by the LLM; and
a resolution request for the request rejection;
wherein the copy of the template is populated by enriching the resolution request with the at least part of the related request code text and the at least part of the resolution text.

15. The computer program product of claim 11, wherein using at least the rejected request code to retrieve the related request code text from the first document comprises:
using the rejected request code to identify at least one keyword for the rejected request code characterization; and
using the at least one keyword to identify, as the respective additional request code characterizations, those ones of candidate characterizations in the first document that contain at least one of the at least one keyword.

16. A data processing system comprising at least one processor and memory coupled to the at least one processor, wherein the memory contains instructions which, when executed by the at least one processor, cause the data processing system to implement a method comprising:
obtaining rejection information for a request rejection for the rejected request, the rejection information comprising:
a rejected request code for the rejected request; and
a refusal code for the rejected request;
extracting, from the rejection information, the rejected request code and the refusal code;
using at least the rejected request code to retrieve related request code text from a first document;
wherein the related request code text comprises:
a rejected request code characterization for the rejected request code itself; and
additional request codes that are related to the rejected request code and respective additional request code characterizations for the additional request codes;
using the refusal code to retrieve at least one resolution text from a second document;
dynamically combining at least part of the related request code text and at least part of the resolution text into a prompt requesting a recommendation for resolving the request rejection; and
submitting the prompt to an LLM.

17. The data processing system of claim 16, wherein using at least the rejected request code to retrieve the related request code text from the first document comprises:
using the rejected request code to obtain a rejected request code text embedding for the rejected request code characterization;
comparing the rejected request code text embedding to candidate text embeddings for respective corresponding candidate characterizations in the first document to identify a subset of the candidate text embeddings that are similar to the rejected request code text embedding according to a similarity threshold; and
returning, as the respective additional request code characterizations, those of the candidate characterizations for which the respective corresponding candidate text embeddings satisfy the similarity threshold.

18. The data processing system of claim 16, wherein the method further comprises;
extracting supplemental data from request history data for a subject of the request; and
before submitting the prompt to the LLM, incorporating at least part of the supplemental data into the prompt.

19. The data processing system of claim 16, wherein the prompt comprises a populated copy of a template, wherein the template comprises:
an identifier of a persona to be adopted by the LLM; and
a resolution request for the request rejection;
wherein the copy of the template is populated by enriching the resolution request with the at least part of the related request code text and the at least part of the resolution text.

20. The data processing system of claim 16, wherein using at least the rejected request code to retrieve the related request code text from the first document comprises:
using the rejected request code to identify at least one keyword for the rejected request code characterization; and
using the at least one keyword to identify, as the respective additional request code characterizations, those ones of candidate characterizations in the first document that contain at least one of the at least one keyword.
